(19) United States
(12) Patent Application Publication
(10) Pub. No.: US 2004/0004597 A1
(43) Pub. Date: Jan. 8, 2004

(54) Capacitor structure in a low temperature poly silicon display

(76) Inventors: Nien-Hui Kung, Miao-Li Hsieu (TW); Jr-Hong Chen, Hsinchu Hsien (TW)

Correspondence Address: Supreme Patent Services, Post Office Box 2339, Saratoga, CA, 95070-0339, US

(21) Appl. No.: 10/251,710

(22) Filed: Sep. 21, 2002

(30) Foreign Application Priority Data
Jul. 4, 2002 (TW) 91114789

(51) Int. Cl. G09G 3/34

(52) U.S. Cl. 345/106

(57) ABSTRACT

A capacitor structure in a low temperature poly silicon display comprises a buffer layer on a substrate, a poly-Si layer on the buffer layer, a dielectric layer on the poly-Si layer, and an electrically conductive layer on the dielectric layer. At least one of the four layers has an uneven structure. Combining the capacitor structure of the invention with a thin film transistor formed by a LTPS fabrication process forms a pixel structure of a LTPS thin film transistor display. Comparing to the capacitor structure in a conventional display, the capacitor structure of the invention increases the area of the capacitor. Therefore, the storage capacity and the aperture ratio of the LTPS display are increased. The fabrication process is simple. Only one extra process is added to the conventional LTPS display fabrication process and the quality of the display is greatly enhanced.

### FIELD OF THE INVENTION

The present invention relates generally to a structure in a low temperature poly silicon (LTPS) display, and more specifically to a capacitor structure in a low temperature poly silicon display.

### BACKGROUND OF THE INVENTION

Recently, manufacturing technologies for a semiconductor display device using a low temperature fabrication process become very popular. One significant technology is the formation of a thin film transistor (TFT) display device using the low temperature poly silicon fabrication process. FIG. 1a shows a cross-sectional view of a pixel structure of a display fabricated by a conventional LTPS process. The fabrication process of such a pixel structure mainly comprises the following steps. Firstly, a buffer layer 103 is formed on a substrate 101. Secondly, a poly-Si layer 105 is formed on the buffer layer 103. Then the poly-Si layer 105 is etched by a photolithography process, and a dielectric layer 107 is formed to cover the whole substrate. On the dielectric layer 107, a first metal layer 109 is formed, and etched by a photolithography process to form a gate region 111. A passivation layer 113 is further formed to cover the whole substrate. Finally, on the passivation layer 113, a second metal layer is formed and etched to form the source region 115 and the drain region 117. The source region 115 and the drain region 117 can be formed by an ion implantation method.

In the conventional low temperature poly silicon process, the storage capacity of the capacitor structure in a display is limited and the area of the capacitor is restricted when the leak current in the thin film transistor is concerned. Therefore, the aperture ratio of a pixel area is restricted too. FIG. 1b shows a capacitor structure of the pixel structure shown in FIG. 1a. Referring to FIG. 1b, the conventional capacitor structure in a low temperature poly silicon display comprises four flat layers on a substrate 101. These four flat layers are a buffer layer 103, a poly-Si layer 105 on the buffer layer 103, a dielectric layer 107 on the poly-Si layer 105, and an electrically conductive layer 110 on the dielectric layer 107. The electrically conductive layer 110 is generally a metal layer.

There are many ways to increase the aperture ratio of a display. This invention provides a particular capacitor structure to increase the storage capacity and further to increase the aperture ratio of a low temperature poly silicon display.

### SUMMARY OF THE INVENTION

The present invention has been made to overcome the above-mentioned drawbacks of a conventional capacitor structure in a low temperature poly silicon display that has a limited storage capacity. The primary object is to provide a capacitor structure of a low temperature poly silicon display. This invention adds an extra etching process to the conventional fabrication process of a low temperature poly silicon display so that at least one of the buffer layer, the poly-Si layer, the dielectric layer and the conductive layer on a substrate has an uneven structure. The uneven structure increases the capacitor area and, hence, the storage capacity. The aperture ratio of the low temperature poly silicon display is also increased.

According to the invention, the capacitor structure in a low temperature poly silicon display comprises a buffer layer on a substrate, a poly-Si layer on the buffer layer, a dielectric layer on the poly-Si layer, and an electrically conductive layer on the dielectric layer, wherein at least one of the four layers has an uneven structure with some shape.

In the preferred embodiment of the invention, at least one of the four layers has a convex and/or concave uneven structure with depth greater than 100 angstrom (Å). Also, the number of layers having uneven structure can be one (dielectric layer), two (dielectric layer and conductive layer) or four (buffer layer, poly-Si layer, dielectric layer and conductive layer).

According to the invention, there is no restriction on the pattern of uneven structures. The preferred range of height for the buffer layer is approximately less than 5 μm. The preferred range of height for the poly-Si layer is approximately less than 1000 Å. The preferred range of height for the dielectric layer is approximately less than 2000 Å. The preferred range of height for the conductive layer is approximately less than 1000 Å.

The fabrication process for the capacitor structure in a low temperature poly silicon display of the invention is simple. Only one extra process is added to the conventional manufacturing process for a low temperature poly silicon display The aperture ratio and the quality of the display are greatly increased.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a shows a cross-sectional view of a pixel structure in a conventional fabrication process for a low temperature poly silicon display.

FIG. 1b shows a capacitor structure of the pixel structure shown in FIG. 1a.

FIG. 2 shows a cross-sectional view of a capacitor structure in a low temperature poly silicon display according to the invention.

FIG. 3 shows a cross-sectional view of a capacitor structure in a low temperature poly silicon display where the dielectric layer and the conductive layer have respectively a concave uneven structure according to the invention.

FIG. 4 shows a cross-sectional view of a capacitor structure in a low temperature poly silicon display where all layers have respectively a concave uneven structure according to the invention.

FIG. 5 shows a cross-sectional view of a capacitor structure in a low temperature poly silicon display where all layers have respectively a sinusoidal uneven structure according to the invention.

FIG. 6 shows a cross-sectional view of a pixel structure for a low temperature poly silicon thin film transistor display according to the invention.

### DETAILED DESCRIPTION OF THE PREFERRED EMBODIMENTS

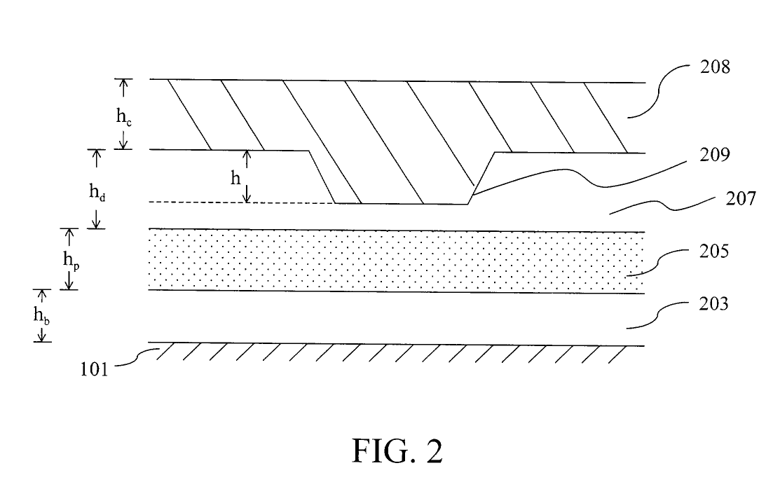

FIG. 2 shows a cross-sectional view of a capacitor structure in a low temperature poly silicon display according to the invention. Referring to FIG. 2, the capacitor structure in the low temperature poly silicon display comprises a buffer layer 203 on the substrate 101, a poly-Si layer 205 on the buffer layer 203, a dielectric layer 207 on the poly-Si layer 205, and an electrically conductive layer 208 on the-dielectric layer 207. At least one of the four layers has an uneven structure. In the preferred embodiment, the dielectric layer 207 has a concave uneven structure 209 The depth h of the concave uneven structure 209 is approximately greater than I 00 angstrom.

In the preferred embodiment of the invention, the material for the buffer layer can be silicon oxide (SiO₂) or silicon nitride (SiNx), and its preferred range of height h_{b} is about less than 5 μm. The preferred range of height hₚ for the poly-Si layer is approximately less than 1000 Å. The material for the dielectric layer can be SiO₂, SiNx, TaOx or TiOx, and its preferred range of height h_{d} is approximately less than 2000 Å. The material for the conductive layer is generally a metal, and its preferred range of height h_{c} is approximately greater than 1000 Å.

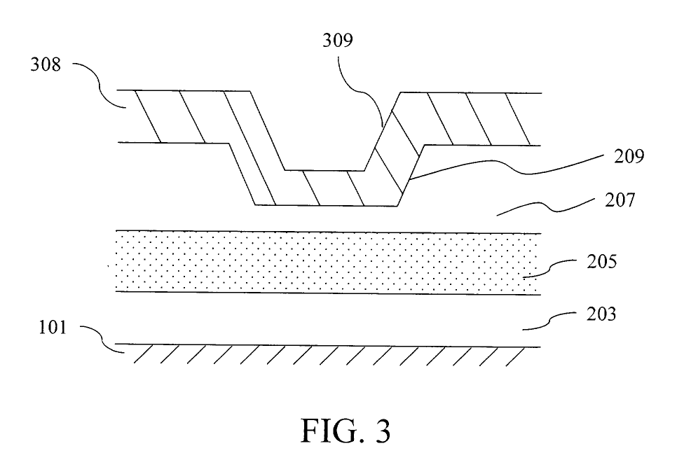

In the capacitor structure of the low temperature poly silicon display of the invention, both the dielectric layer and the conductive layer can have respectively a concave uneven structure as shown in FIG. 3. Referring to FIG. 3, the dielectric layer 207 has a concave uneven structure 209 and the electrically conductive layer 308 on the dielectric layer 207 also has a concave uneven structure 309.

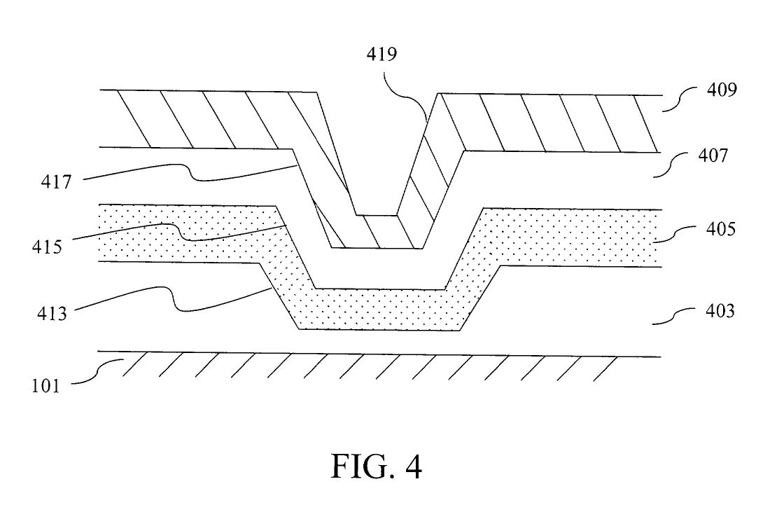

In the capacitor structure of the invention, all layers can have respectively a concave uneven structure as shown in FIG. 4. Referring to FIG. 4, the buffer layer 403 on the substrate 101 has a concave uneven structure 413, the poly-Si layer 405 has a concave uneven structure 415, the dielectric layer 407 has a concave uneven structure 417 and the conductive layer 409 has a concave uneven structure 419.

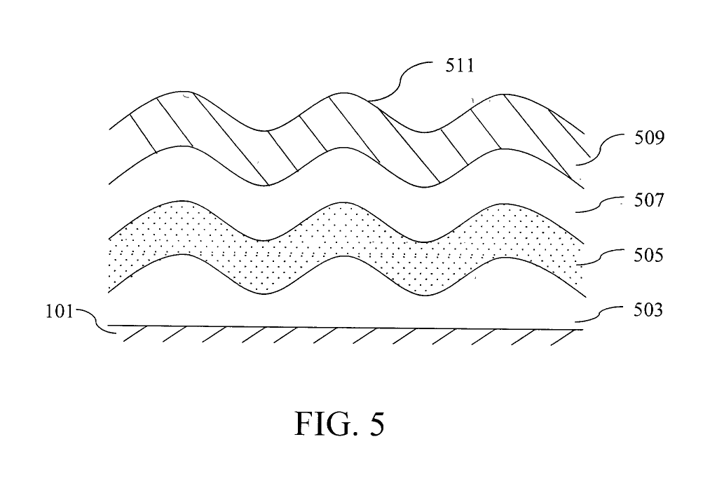

According to the invention, the pattern or shape of uneven structures is very flexible. In addition to the concave uneven structure mentioned above, the uneven structure can be a sinusoidal uneven structure or a convex uneven structure. FIG. 5 shows a cross-sectional view of a capacitor structure in a low temperature poly silicon display where every layer has a sinusoidal uneven structure. Referring to FIG. 5, the buffer layer 503, the poly-Si layer 505, the dielectric layer 507 and the conductive layer 509 have respectively a sinusoidal uneven structure 511.

This invention adds an extra etching process to the conventional fabrication process for a low temperature poly silicon display so that at least one of the buffer layer, the poly-Si layer, the dielectric layer and the conductive layer on a substrate has an uneven structure of some pattern.

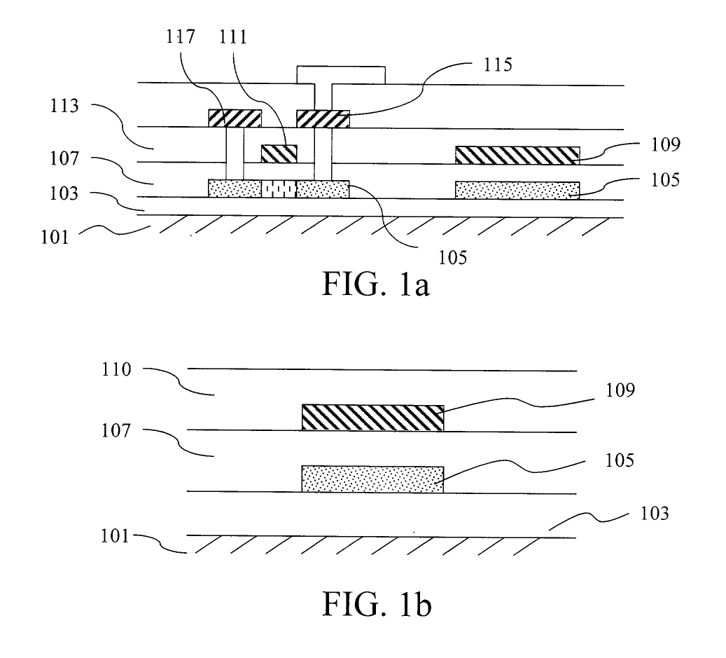

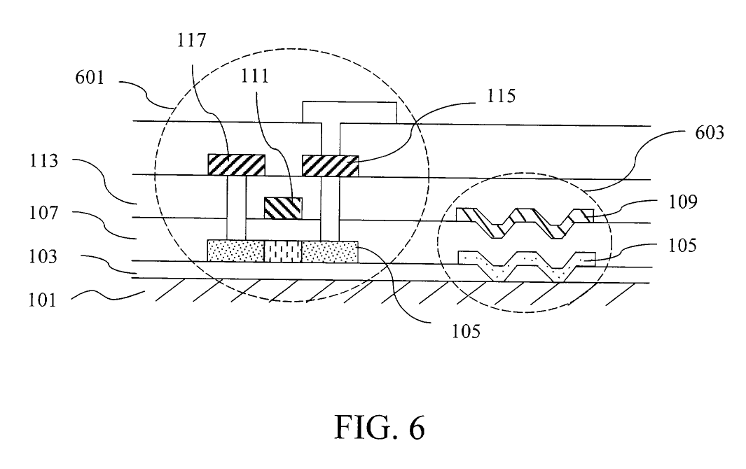

Combining the capacitor structure of the invention with a thin film transistor formed by the low temperature poly silicon fabrication process can form a pixel structure of a low temperature poly silicon thin film transistor display. FIG. 6 shows a cross-sectional view of a pixel structure of a low temperature poly silicon thin film transistor display. The pixel structure comprises a portion of a low temperature poly silicon thin film transistor substrate 601 as shown in FIG. 1a and a capacitor structure 603 of the invention having uneven structures.

In summary, comparing to the capacitor structure of a conventional low temperature poly silicon thin film transistor display, the uneven capacitor structure of the invention increases the area of the capacitor. Therefore, the storage capacity and the aperture ratio of the display are increased. Only one extra process is needed and the quality of the display is greatly increased.

Although this invention has been described with a certain degree of particularity, it is to be understood that the present disclosure has been made by way of preferred embodiments only and that numerous changes in the detailed construction and combination as well as arrangement of parts may be restored to without departing from the spirit and scope of the invention as hereinafter set forth.

What is claimed is:

1. A capacitor structure in a low temperature poly silicon display comprising:
a buffer layer formed on a substrate;
a poly-Si layer formed on said buffer layer;
a dielectric layer formed on said poly-Si layer; and
an electrically conductive layer formed on said dielectric layer;
wherein at least one of said four layers has an uneven structure.

2. The capacitor structure in a low temperature poly silicon display as claimed in claim 1, wherein the thickness of said buffer layer is approximately less than 5 μm, the thickness of said poly-Si layer is approximately less than 1000 Å, the thickness of said dielectric layer is approximately less than 2000 Å, and the thickness of said conductive layer is approximately less than 1000 Å.

3. The capacitor structure in a low temperature poly silicon display as claimed in claim 1, wherein at least one of said four layers has a concave uneven structure with depth greater than 100 angstroms.

4. The capacitor structure in a low temperature poly silicon display as claimed in claim 1, the material for said buffer layer being silicon oxide or silicon nitride.

5. The capacitor structure in a low temperature poly silicon display as claimed in claim 1, the material for said dielectric layer being silicon oxide, silicon nitride, tantalum oxide or titanium oxide.

6. The capacitor structure in a low temperature poly silicon display as claimed in claim 1, said buffer layer having a convex or concave uneven structure.

7. The capacitor structure in a low temperature poly silicon display as claimed in claim 1, said buffer layer having convex and concave uneven structures.

8. The capacitor structure in a low temperature poly silicon display as claimed in claim 1, both said dielectric layer and said conductive layer having respectively a convex or concave uneven structure.

9. The capacitor structure in a low temperature poly silicon display as claimed in claim 1, both said dielectric layer and said conductive layer having convex and concave uneven structures.

10. The capacitor structure in a low temperature poly silicon display as claimed in claim 1, each layer of said four layers having a convex or concave uneven structure.

11. The capacitor structure in a low temperature poly silicon display as claimed in claim 1, each layer of said four layers having convex and concave uneven structures.

12. The capacitor structure in a low temperature poly silicon display as claimed in claim 1, at least one of said four layers having a sinusoidal uneven structure.

13. A pixel structure of a low temperature poly silicon thin film transistor display having a capacitor structure comprising:
a buffer layer formed on a substrate;
a poly-Si layer formed on said buffer layer;
a dielectric layer formed on said poly-Si layer; and
an electrically conductive layer formed on said dielectric layer;
wherein at least one of said four layers has an uneven structure.
